(19) United States
(12) Patent Application Publication
(10) Pub. No.: US 2004/0179226 A1
(43) Pub. Date: Sep. 16, 2004

(54) Accelerating printing

(76) Inventors: Theresa A. Burkes, Meridian, ID (US); Chris R. Gunning, Boise, ID (US); Sandra Capri, Middleton, ID (US); Michael B. Lloyd, Meridian, ID (US); Bret A. Funke, Boise, ID (US); Tommy Mouser, Star, ID (US); Brian L. Watts, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/385,382

(22) Filed: Mar. 10, 2003

(51) Int. Cl. G06F 15/00; H04N 1/46

(52) U.S. Cl. 358/1.15; 358/504; 358/474

(57) ABSTRACT

An exemplary device includes: a scanner capable of beginning a scan of a scanning target and providing timing-related information for the scan; and a printer capable of printing an image of the scanning target and receiving the timing-related information, the printer including a print engine; wherein the printer is adapted to activate the print engine prior to receiving all scan lines of the scanning target responsive to the timing-related information. An exemplary method for accelerating printing includes actions of: beginning a scan of a scanning target; determining timing-related information from the scan; and sending an instruction to a print engine responsive to the timing-related information and prior to completing the scan.

### BACKGROUND

Multifunction devices in modern office environments or other document management/production environments are used to perform functions that often previously used multiple separate devices. These functions can include printing, copying, scanning, faxing, document transmission by other means, and so forth.

Copying functions, in effect, can be accomplished by combining scanning and printing functions. Consequently, the type of print engine used for the printing function can affect various characteristics of the copying function. One print engine type that is used for the printing function is a laser printer. With laser printers, a period of time is consumed while making the print engine ready for printing. However, the print engine maintaining a ready state indefinitely causes wear and tear.

In a copying operation using a scanner and a laser printer, a tradeoff may exist between the time used to complete the copying operation and the incremental wear and tear experienced by the laser printer as a result of the copying operation. For example, steps taken to reduce the incremental wear and tear experienced by the laser printer to perform a copying operation may lengthen the time used to perform the copying operation.

### SUMMARY

An exemplary device includes: a scanner capable of beginning a scan of a scanning target and providing timing-related information for the scan; and a printer capable of printing an image of the scanning target and receiving the timing-related information, the printer including a print engine; wherein the printer is adapted to activate the print engine prior to receiving all scan lines of the scanning target responsive to the timing-related information. An exemplary method for accelerating printing includes actions of: beginning a scan of a scanning target; determining timing-related information from the scan; and sending an instruction to a print engine responsive to the timing-related information and prior to completing the scan.

### BRIEF DESCRIPTION OF THE DRAWINGS

In the Drawings, like numerals are used for like and/or corresponding features, aspects, and components of the various FIGS. 1-8.

FIG. 1 is an exemplary multifunction device that includes a scanner and a printer.

FIG. 2 is an implementation of a multifunction device that illustrates exemplary components thereof.

FIG. 3 illustrates an exemplary scanning target.

FIG. 4 illustrates an exemplary general approach to accelerating printing with a multifunction device.

FIG. 5 is a flow diagram that illustrates an exemplary general method for accelerating printing with a multifunction device.

FIG. 6 illustrates an exemplary approach to accelerating printing with a multifunction device when copying a first scanning target of a copying batch.

FIG. 7 illustrates an exemplary approach to accelerating printing with the multifunction device when copying a subsequent scanning target of the copying batch.

FIG. 8 is a flow diagram that illustrates an exemplary specific method for accelerating printing with a multifunction device.

### DETAILED DESCRIPTION

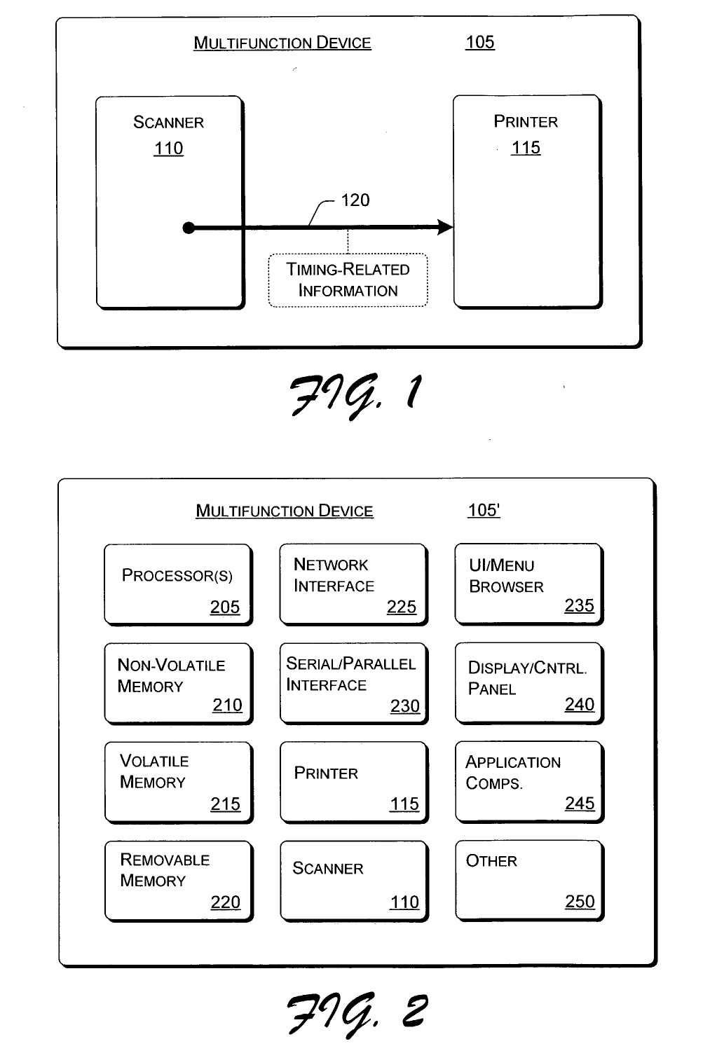

FIG. 1 is an exemplary multifunction device 105 that includes a scanner 110 and a printer 115. In a described implementation, scanner 110 communicates with printer 115 regarding timing-related information 120 over one or more links (not explicitly shown). Timing-related information 120 may include a first scan strip (as described further below with reference to FIG. 3), a time remaining indicator (as described further below with reference to FIGS. 6-8), some combination thereof, and so forth. Because the remaining time to complete a scan is predictable after the first scan strip of a scanning target is completed, printer 115 can better manage the states of a print engine thereof. Generally, printer 115 can cause the print engine thereof to begin preparing for printing prior to the complete scanning of the scanning target by scanner 110. Specifically, if the time remaining for the scanner 110 to complete the entire scanning is less than or equal to the time to prepare the print engine of printer 115, then printer 115 causes its print engine to begin preparing for printing.

Multifunction device 105 is capable of performing two or more functions such as printing, copying, scanning, faxing, document transmission by other means, and so forth. Hence, in addition to one or more scanners 110 and one or more printers 115, multifunction device 105 may also include other components directed to faxing, network communication, and so forth. Scanner 110 and printer 115 may be considered as a scanning component (e.g., a scanning unit) and a printing component (e.g., a printing unit), respectively. Scanner 110 and printer 115 may be usable separately and/or jointly as a copying component or components.

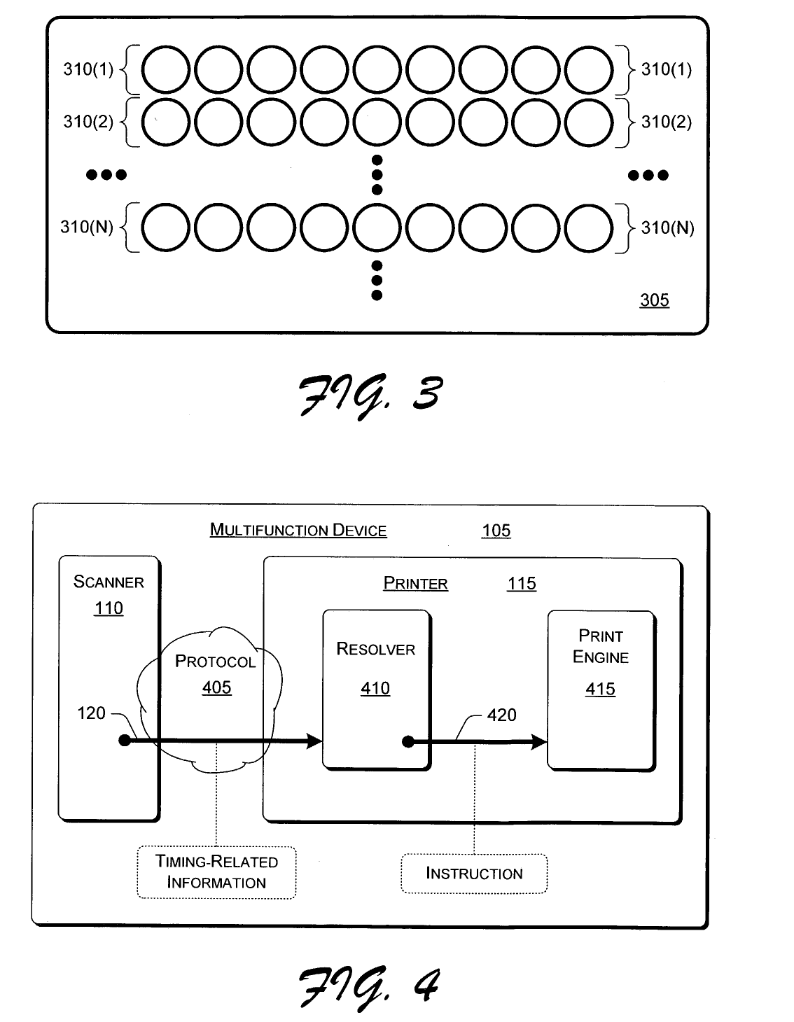

FIG. 2 is a multifunction device implementation 105′ that illustrates exemplary components 110, 115, and 205-250. Any particular multifunction device implementation 105′ need not include most, much less all, of the exemplary components 205-250. Nevertheless, in the described implementation of FIG. 2, multifunction device 105′ includes one or more processors 205, non-volatile memory 210, volatile memory 215, and removable memory 220. Processor(s) 205 process various instructions to control the operation of multifunction device 105′ and to communicate with other electronic and/or computing devices. Memories 210, 215, and/or 220 may store these instructions, as well as other information and data such as that for scanning, copying, faxing, and printing.

Non-volatile memory 210 may include read-only (non-erasable) memory (ROM), flash memory, programmable read-only memory (PROM), electrically programmable read-only memory (EPROM), electrically erasable programmable read-only memory (EEPROM), some other non-volatile (e.g., solid state) memory, and so forth. Non-volatile memory 210 may also include a mass memory such as a disk-based storage system. Regardless, non-volatile memory 210 may store boot-level/initialization code, basic identification, and/or alterable or unalterable operational information such as firmware, and so forth.

Volatile memory 215 is typically a random access memory (RAM). Volatile memory 215 holds information that is needed on a transient basis such as printing, faxing, copying, or scanning data; current processing instructions; electronic documents for current manipulation/transmission; and so forth. Removable memory 220 may include a floppy drive, a removable hard drive, a removable flash memory cartridge/module, a proprietary format (e.g., a ZIP (® drive), and so forth. Removable memory 220 may hold document information, new or revised instructions/firmware, and so forth.

Multifunction device 105′ also includes a network interface (e.g., adapter) 225, and a serial and/or parallel interface (e.g., adapter) 230. Network interface 225 may provide a connection between multifunction device 105′ and a data communication network (or a specific device connected over a network-type medium). Network interface 225 allows devices coupled to a common data communication network to send print jobs, faxes, and other information to multifunction device 105′ via the data communication network. Similarly, serial and/or parallel interface 230 may provide a data communication path directly between multifunction device 105′ and another electronic and/or computing device. Multifunction device 105′ may alternatively substitute or add another interface adapter type, such as a Universal Serial Bus (USB) interface adapter, an IEEE 1394 (“Firewire”) interface adapter, a wireless interface (e.g., Bluetooth®, IEEE 802.11 b, wireless Local Area Network (LAN), etc.) adapter, and so forth.

Multifunction device 105′ also includes printer 115 that typically includes one or more mechanisms arranged to selectively apply pigment (e.g., toner) to a print media such as paper, plastic, fabric, and the like in accordance with print data corresponding to a print job, including those print jobs arriving via scanner 110 (e.g., possibly to support a copying function). For example, printer 115 may include a laser printing mechanism that selectively causes toner to be applied from toner container(s)/cartridge(s) to an intermediate surface of a drum or belt that spins. The intermediate surface can then be brought into the proximity of a print media in a manner that causes the toner to be transferred to the print media in a controlled fashion. The toner on the print media can then be more permanently fixed to the print media, for example, by selectively applying thermal energy to the toner. Alternatively, printer 115 may include an ink jet printing mechanism that selectively causes liquid ink to be extracted from ink container(s) and ejected through print head nozzles and onto print media to form an intended pattern (e.g., text, pictures, etc.).

Printer 115 may also be designed or configured to support duplex printing, for example, by selectively flipping or turning the print media as required to print (including to copy) on both sides. There are many different types of printing units available, and printer 115 may be comprised of any one or more of these different types. Although not explicitly shown, a system bus or busses (or other communication links) may connect and interconnect the various illustrated components 110, 115, and 205-250 of multifunction device 105′. For example, a communication link exists between printer 115 and scanner 110 in order for scanner 110 to communicate scan data and other information to printer 115.

Multifunction device 105′ thus includes scanner 110 that can be implemented as an optical or other scanner to produce machine-readable/understandable image data signals that are representative of a scanning target, such as a photograph, a page of printed text, an object, and so forth. The image data signals produced by scanner 110 can be used to reproduce an image of the scanning target, such as on a computer monitor or print media (e.g., via printer 115).

Multifunction device 105′ may also include a user interface (UI) and/or menu browser 235 and a display and/or control panel 240. The UI and/or menu browser 235 allows a user of multifunction device 105′ to navigate the device's menu structure (if any). A display aspect of display and/or control panel 240 may be a graphical and/or textual display that provides information regarding, e.g., the status of multifunction device 105′ and the current options available to a user through, e.g., a menu structure. Any such graphical and/or textual display may be realized using a liquid crystal display (LCD) screen, a cathode ray tube (CRT) screen, a plasma screen, a light emitting diode (LED) screen, a video screen, and so forth. A control aspect of display and/or control panel 240, on the other hand, may be composed of indicators and/or a series of buttons, switches, or other selectable controls that are manipulated by a user of multifunction device 105′.

Multifunction device 105′ may, and typically does, include application components 245 that provide a runtime environment in which software applications or components can run or execute. There are many different types of available runtime environments, which facilitate the extensibility of multifunction device 105′ by allowing various interfaces to be defined that, in turn, allow application components 245 to interact with multifunction device 105′. Other components, whether comprised of hardware, software, firmware, or some combination thereof, may also be part of multifunction device 105′, as indicated by the other block 250.

FIG. 3 illustrates an exemplary scanning target 305. Scanning target 305 may be any physical media such as paper, cloth, a three-dimensional object, and so forth. For example, scanning target 305 may comprise a document such as loose paper, magazines, books, and so forth. Scanners 110 typically scan one line at a time from the top of scanning target 305 to the bottom of scanning target 305. It should be noted that any side or portion of scanning target 305 may be defined as the top or bottom of scanning target 305.

Scanning target 305 includes indications of multiple scanning lines 310, from a first scan line 310(1), to a second scan line 310(2) . . . to an n^{th} scan line 310(N). Scan lines 310 may refer to a physical line of scanning target 310 and/or image data signals that are representative of a physical line of scanning target 310 as scanned in by scanner 110. In a described implementation, first scan line 310(1) is transmitted first to printer 115. However, scan lines 310 may be transferred to printer 115 in any order.

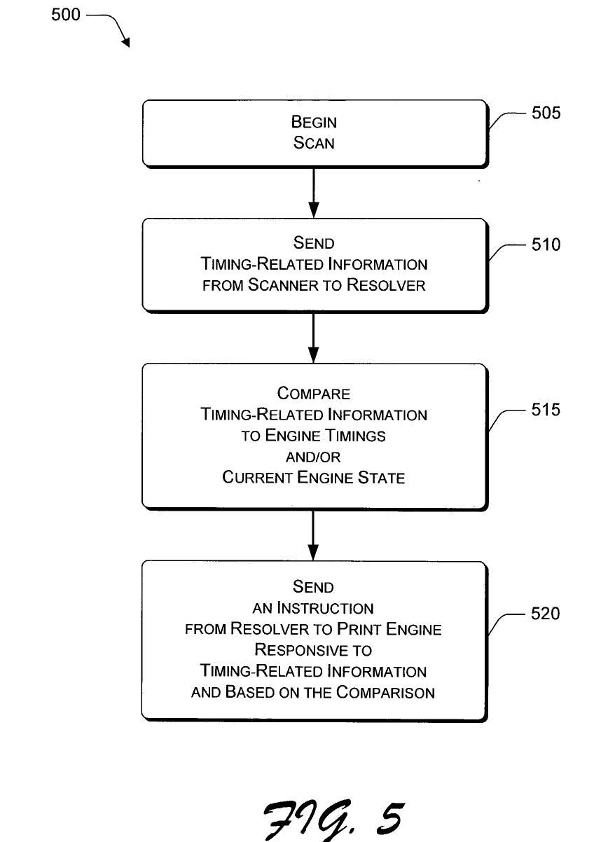

FIG. 4 illustrates an exemplary general approach to accelerating printing with a multifunction device 105. Multifunction device 105 includes scanner 110 and printer 115, as well as timing-related information 120. Multifunction device 105 also includes a protocol 405, a resolver 410, and a print engine 415. As described further below, protocol 405 facilitates communication between scanner 110 and resolver 410. Protocol 405 may be located on scanner 110, on printer 115, and/or may be a construct for communicating designated information. Resolver 410 manages, at least in part, changes in the states of print engine 415 via one or more instructions 420.

Resolver 410 may be realized, for example, as part of a formatter board of printer 115. Although resolver 410 is illustrated as part of printer 115, it may alternatively be fully or partially realized as part of scanner 110 or another (unillustrated) component of multifunction device 105. Print engine 415 includes the mechanics, the laser (if printer 115 is a laser printer), etc. that are used by print engine 415 to render images on media. Print engine 415 is associated with one or more characteristics. These characteristics include print engine states, print engine timings, and so forth.

In a described implementation, print engine 415 may be considered to be in one of multiple print engine states. These states include active and inactive. An active state refers to when print engine 415 is in either a ready-to-print state or in a terminating-a-ready-condition state. An inactive state refers to when print engine 415 is neither ready nor terminating a ready state.

As noted above, there is a period of time that is consumed when taking print engine 415 from an inactive state to a ready-to-print state, or ready state. This period of time is consumed by, for example, the following processes: warming up the fuser, cleaning, calibration, and so forth. There is also a period of time consumed when taking print engine 415 from a terminating-a-ready-condition state to a ready state. Because there is usually at least a moment in which a print engine is at an inactive state when moving from a terminating-a-ready-condition state to a ready state, there is a consequentially even longer period of time to take print engine 415 from the terminating-a-ready-condition state back to the ready state.

Another characteristic of print engine 415, in addition to print engine states, relates to print engine timings. These print engine timings relate to the time period(s) that are consumed when changing to and between the various states enumerated above. For example, print engine 415 may take “X” seconds, “Y” milliseconds, etc. to move from an inactive/idle state to a ready state. These engine timings may include details regarding sub-activities undertaken by print engine 415 in order to switch states. An example of such a sub-activity is the warming up of the fuser when switching to a ready state. Engine timings for print engine 415 may also relate to other timings regarding the operation of print engine 415 in addition to those regarding switching print engine states.

Print engine 415 may communicate these characteristics, either or both of print engine states and print engine timings, to resolver 410. Such communication may occur once by way of specification or repeatedly via real-time, dynamic status updates. Resolver 410 may also be furnished any or all of these characteristics by way of specification from another source, either during manufacturing or thereafter. Resolver 410 may further be given the ability to model print engine states and print engine timings, as well as interrelationships therebetween.

In a described implementation, multifunction device 105 (of FIG. 4) operates generally as follows: Scanner 110 begins a scan of scanning target 305. After a first scan line 310(1) has been scanned, a time for completing the entire scan can be predicted because scanning is usually executed in an orderly and straightforward manner. Scanner 110 transmits timing-related information 120 to resolver 410 via protocol 405. Timing-related information 120 may include first scan line 310(1) and/or a time remaining indicator.

Protocol 405 enables a time remaining indicator to be communicated separately from and/or contemporaneously with the transmission of first scan line 310(1). For example, although first scan line 310(1) and a time remaining indicator may be transmitted to printer 115, protocol 405 may instead only forward the time remaining indicator to resolver 410. Alternatively, resolver 410 may be furnished with an expected scanning time per document, which enables resolver 410 to predict the completion of an entire scan after receiving any given first scan line 310(1). Thus, resolver 410 may derive a predicted time of scanning completion from timing-related information 120.

Resolver 410 utilizes timing-related information 120 and characteristics of print engine 415 in an analysis to determine what state print engine 415 should be in and consequently should be changed to, if necessary. In other words, resolver 410 compares timing-related information 120 to a current state and general timings of print engine 415 in order to determine what state print engine 415 should be in so as to balance printing time against undue wear and tear of print engine 415. Resolver 410 thus acts as a real-time decision maker, and it issues instruction(s) 420 responsive to its determinations. For example, if print engine 415 is not in a ready state (because it is either terminating a previous ready state or sitting idle), and a scanning target 305 is predicted to be fully scanned within the period of time normally consumed when initializing print engine 415, resolver 410 issues an instruction 420 to print engine 415 that causes print engine 415 to initialize itself into a ready state (e.g., to spin up print engine 415).

Implementations of printing acceleration may be described in the general context of electronically-executable instructions. Generally, electronically-executable instructions include routines, programs, objects, components, data structures, and the like that perform particular functions or implement particular abstract data types. Printer acceleration implementations may also be effectuated in distributed environments where functions are performed by components that are remote from each other but are connected through a communications link. Especially in such distributed environments, electronically-executable instructions may be located in both local and remote storage media, as well as in signals extant on one or more transmission media.

The methods of FIGS. 5 and 8 are illustrated in flow diagrams divided into multiple method blocks. However, the order in which the methods are described is not intended to be construed as a limitation, and any number of the described method blocks can be combined in any order to execute one or more methods for accelerating printing. Furthermore, although the methods of FIGS. 5 and 8 are described below with reference to multifunction device 105 and FIGS. 1-4, 6, and 7 where applicable, the methods can be implemented in any suitable hardware, software, firmware, or combination thereof and using any appropriate printing and scanning (including copying) component(s).

FIG. 5 is a flow diagram 500 that illustrates an exemplary general method for accelerating printing with a multifunction device 105. In other words, flow diagram 500 illustrates how a copying function can be expedited by tuning print engine management and increasing inter-component communication. Flow diagram 500 includes four (4) method blocks 505-520. At block 505, a scan is begun at a scanning component. For example, an operator can start a scan/copy at a scanner 110(i) by pressing a button or selecting a menu option therefor directly on a multifunction device 105 or (ii) by sending a scan/copy command indirectly to the multifunction device 105 (e.g., via a computer coupled thereto).

At block 510, timing-related information is sent from the scanner to a resolver. For example, timing-related information 120 may be sent from the scanner 110 to a resolver 410 of a printer 115 using a protocol 405. At block 515, timing-related information is compared to engine timings and/or a current engine state. For example, the resolver 410 can compare the timing-related information 120 to one or more characteristics of print engine 415 of the printer 115.

At block 520, an instruction is sent from the resolver to a print engine responsive to the timing-related information and based on the comparison (of block 515). For example, an instruction 420 may be sent from the resolver 410 to the print engine 415. As is described further below with reference to FIGS. 6-8, the instruction 420 may be comprised of an initialize instruction, a continue spinning instruction, a cease spinning instruction, and so forth. For example, an initialize instruction may be sent to the print engine 415 when the print engine 415 is in a non-ready state and the time to become ready equals or exceeds the predicted time remaining to complete the scan.

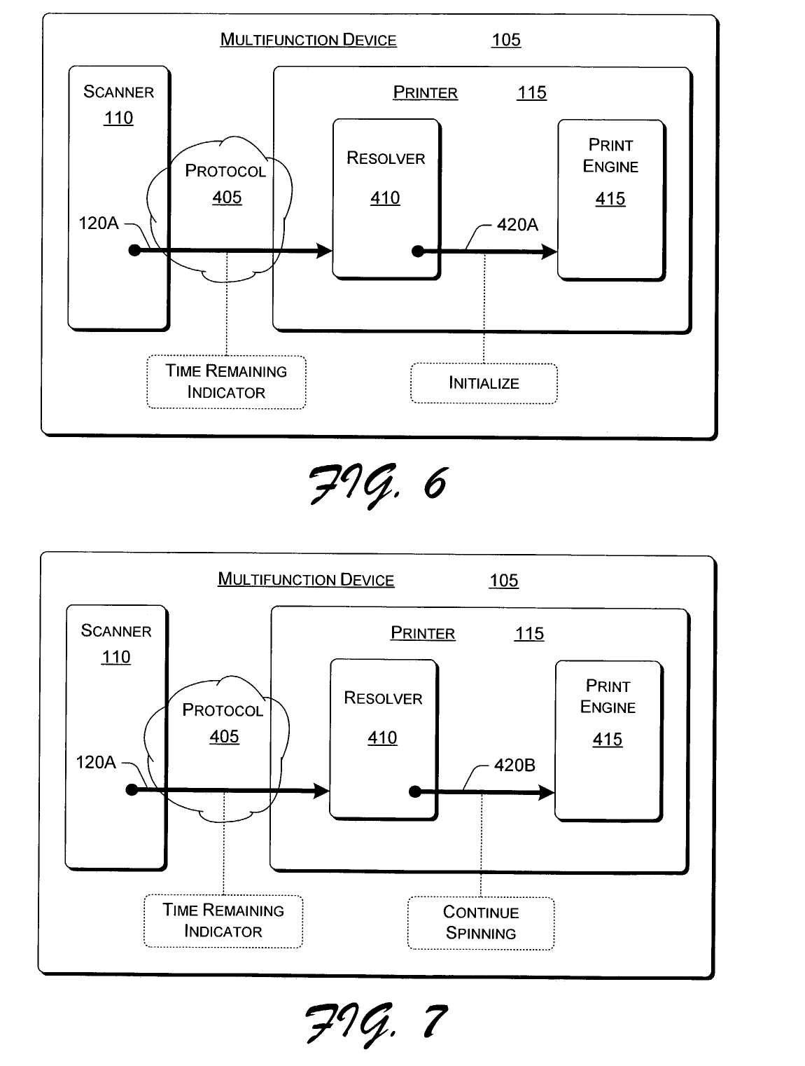

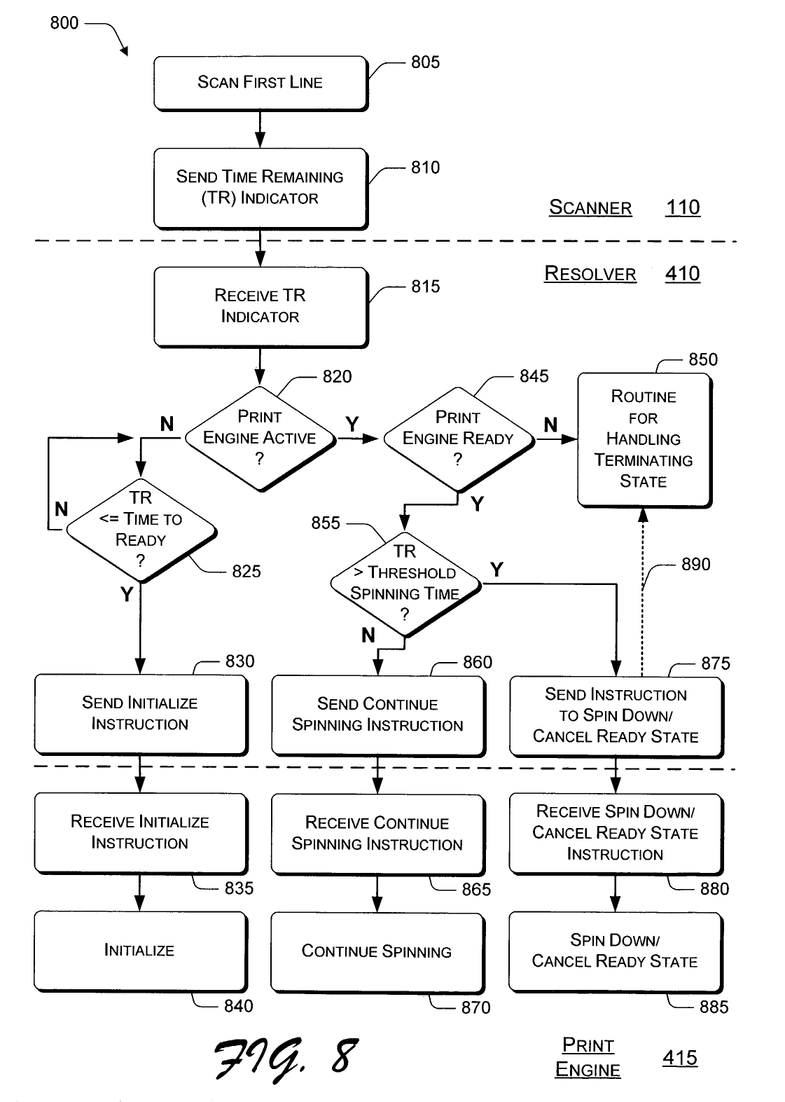

An initialize instruction can be applicable to the scanning and printing of any scanning target 305 in a batch of scanning targets 305, including a first such scanning target 305. On the other hand, a continue spinning instruction is typically applicable to the scanning and printing of non-first scanning targets 305 in a batch of scanning targets 305, including a second and subsequent scanning targets 305. FIG. 6 is directed at least partly to an initialize instruction 420A, and FIG. 7 is directed at least partly to a continue spinning instruction 420B. FIGS. 6-8 are each directed to a specific exemplary implementation of multifunction device 105 in which a time remaining indicator 120A is provided to resolver 410 from scanner 110 via protocol 405.

FIG. 6 illustrates an exemplary approach to accelerating printing with multifunction device 105 when copying a first scanning target of a copying batch. In this exemplary approach, scanner 110 transmits a time remaining indicator 120A to resolver 410 using protocol 405. Resolver 410 compares a time remaining from time remaining indicator 120A to a time for bringing print engine 415 of printer 115 to a ready state. Resolver 410 may count down the time remaining and/or receive time remaining updates from scanner 110 as necessary. If the time remaining is, or when the time remaining becomes, less than or equal to the time to bring print engine 415 of printer 115 to a ready state, resolver 410 sends an initialize instruction 420A to print engine 415. The comparison may also be made with some flexibility such that the time remaining is compared to approximately the time period for readying print engine 415.

FIG. 7 illustrates an exemplary approach to accelerating printing with multifunction device 105 when copying a subsequent scanning target of the copying batch. In this exemplary approach, scanner 110 transmits a time remaining indicator 120A to resolver 410 using protocol 405. This time remaining indicator 120A for each subsequent scanning target may be transmitted along with the first scan line 310(1) thereof. Resolver 410 manages printing states of print engine 415 so as to optimize, or at least increase, throughput on second and subsequent scanning (or copying) targets of a copying batch without incurring, or at least reducing, undue wear and tear on print engine 415. Resolver 410, given a time remaining for a subsequent copying target and print engine characteristic(s), is capable of permitting the overlapping of the scanning of the subsequent copying target with deciding whether to spin down print engine 415 or to keep it spinning.

Thus, after receiving the time remaining, resolver 410 is capable of making real-time decisions regarding whether to issue a command to print engine 415 to keep spinning, or if already spun down, to start spinning up. Such decisions are made with consideration to the time remaining, the state of print engine 415, the timings of print engine 415, and acceptable wear and tear times for print engine 415. A command to keep spinning and therefore remain in a ready state may be made by resolver 410 via the transmission of a continue spinning instruction 420B to print engine 415.

For example, if the engine of print engine 415 is spinning and the next scan will be completed within a time period that does not cause undue wear and tear on the engine, then resolver 410 commands print engine 415 to continue spinning, as indicated by continue spinning instruction 420B. Otherwise, resolver 410 commands print engine 415 to terminate spinning or, optionally, permits the engine of print engine 415 to spin down automatically by not commanding it to continue spinning. If the engine of print engine 415 is not spinning and the next page will be ready within the expected time period to prepare the engine for printing, then resolver 410 issues a command to print engine 415 to start spinning. Hence, an initialize instruction 420A (of FIG. 6) may also be transmitted from resolver 410 to print engine 415 on behalf of second and subsequent scanning targets of a copying batch.

FIG. 8 is a flow diagram 800 that illustrates an exemplary specific method for accelerating printing with a multifunction device 105. Flow diagram 800 includes seventeen (17) method blocks 805-885. The actions of flow diagram 800 may be effectuated by any appropriate components of multifunction device 105. However, in a described implementation, scanner 110 executes actions for blocks 805 and 810; resolver 410 executes actions for blocks 815, 820, 825, 830, 845, 850, 855, 860, and 875; and print engine 415 executes actions for blocks 835, 840, 865, 870, 880, and 885.

At block 805, a first line (e.g., of a page) is scanned. At block 810, a time remaining (TR) indicator that includes the time remaining to complete the scan is sent. At block 815, the TR indicator is received. This TR indicator is transmitted between the scanner 110 and the resolver 410.

At block 820, it is determined whether the print engine is active. If not, then at block 825 it is determined whether the TR is less than or equal to the time that is consumed to ready the print engine for printing. If not, then the method is in a holding pattern that repeats block 825 until the TR falls to or below the time period consumed when spinning up the print engine. When the TR is or becomes less than or equal to the time to ready the print engine (at block 825), flow continues to block 830.

At block 830, an initialize instruction is sent from the resolver 410. At block 835, the initialize instruction is received at the print engine 415. At block 840, the print engine 415 initializes by starting spinning and performing other tasks to prepare the print engine 415 for printing.

If, on the other hand, the print engine is active (as determined at block 820), flow continues to block 845. At block 845, it is determined whether the active print engine is in a ready state. If not, then at block 850 a routine for handling the print engine in a terminating-a-ready-condition state is executed. In such a routine, resolver 410 may immediately begin considering engine timings that include the remaining time to complete a spinning down of the engine, or resolver 410 may wait until the print engine state becomes inactive, in which case flow diagram 800 then continues at block 825. Other options may alternatively be implemented for this routine.

If, on the other hand, the print engine is ready (as determined at block 845), flow continues to block 855. At block 855, the TR is compared to a threshold spinning time to determine whether the TR exceeds the threshold spinning time. This threshold spinning time reflects the maximum time it is prudent to keep the print engine spinning while waiting for receipt of the next page at the print engine. The threshold spinning time may be adjusted to account for operator preferences regarding the tradeoffs between throughput and print engine longevity.

If the TR does not exceed the threshold spinning time (as determined at block 855), flow continues to block 860. At block 860, a continue spinning instruction is sent from the resolver 410. At block 865, the continue spinning instruction is received at the print engine 415. At block 870, the print engine 415 continues spinning in a ready state so as to be prepared to print the next page upon receipt thereof.

If, on the other hand, the TR does exceed the threshold spinning time (as determined at block 855), flow continues to block 875. At block 875, an instruction to spin down/cancel a ready state is sent from the resolver 410. At block 880, the instruction to spin down/cancel a ready state is received at the print engine 415. At block 885, the print engine 415 cancels its ready state by spinning down.

As indicated by dashed arrow 890, the routine at block 850 for handling the print engine when it is in a terminating-a-ready-condition state may be executed by the resolver 410 after sending the instruction to spin down. This routine may vary depending on whether it is executed as a result of block 845 or as a result of block 875. Furthermore, instead of the actions of blocks 875-885, no command may be sent so that the print engine 415 spins down on its own accord and scheduled timing.

Although implementation(s) of apparatuses, methods, systems, and arrangements have been illustrated in the accompanying Drawings and described in the foregoing Detailed Description, it will be understood that the present invention is not limited to the implementation(s) explicitly disclosed, but is capable of numerous rearrangements, modifications, substitutions, etc. without departing from the spirit and scope set forth and defined by the following claims.

What is claimed is:

1. A device comprising:
a scanner capable of beginning a scan of a scanning target and providing timing-related information for the scan; and
a printer capable of printing an image of the scanning target and receiving the timing-related information, the printer including a print engine;
wherein the printer is adapted to activate the print engine prior to receiving all scan lines of the scanning target responsive to the timing-related information.

2. The device of claim 1, wherein the device further comprises:
a fax capable of faxing an image of the scanning target.

3. The device of claim 1, wherein the device comprises at least one of (i) a multifunction peripheral for a computer and (ii) a copier.

4. The device of claim 1, wherein the timing-related information comprises a first scan line of the scanning target.

5. The device of claim 1, wherein the timing-related information comprises a time remaining indicator.

6. The device of claim 1, wherein the printer is further adapted to activate the print engine based on at least one of a print engine timing and a current print engine state.

7. The device of claim 1, wherein the printer is further adapted to activate the print engine prior to the scanner completing the scan of the scanning target.

8. The device of claim 1, wherein the printer is further adapted to deactivate the print engine prior to expiration of a threshold spinning time responsive to the timing-related information.

9. A multifunction device that is capable of accelerating the printing of a scanning target, the multifunction device comprising:
a scanner that is capable of producing an image of a scanning target and that is capable of providing timing-related information that is related to the producing of the image of the scanning target; and
a printer that is capable of printing the image of the scanning target, the printer including a resolver that is capable of receiving the timing-related information and a print engine that has associated characteristics;
wherein the resolver is adapted to analyze the timing-related information in conjunction with the associated characteristics of the print engine to ascertain an instruction for establishing a print engine state.

10. The multifunction device of claim 9, wherein the timing-related information is communicated from the scanner to the resolver using a protocol.

11. The multifunction device of claim 9, wherein the associated characteristics of the print engine include at least one of a current print engine state and a print engine timing.

12. The multifunction device of claim 11, wherein the current print engine state comprises at least one of spinning up, spinning, and spinning down.

13. The multifunction device of claim 11, wherein the print engine timing comprises at least one of a time period to warm up, a time period to attain an idle state from a ready state, and a threshold spinning time.

14. The multifunction device of claim 9, wherein the resolver comprises at least part of a formatter component.

15. The multifunction device of claim 9, wherein the timing-related information comprises a time remaining until the production of the image of the scanning target by the scanner is completed.

16. The multifunction device of claim 9, wherein the timing-related information comprises a first scan line of the image of the scanning target; and wherein the resolver is capable of determining a time remaining until the production of the image of the scanning target by the scanner is completed using a time remaining specification stored at the printer responsive to receipt of the timing-related information.

17. A method for accelerating printing, the method comprising actions of:
beginning a scan of a scanning target;
determining timing-related information from the scan; and
sending an instruction to a print engine responsive to the timing-related information and prior to completing the scan.

18. The method of claim 17, further comprising the action of:
comparing the timing-related information to an engine timing value of the print engine and/or to a current engine state of the print engine.

19. The method of claim 17, further comprising the action of:
sending the timing-related information from a scanner to a resolver.

20. The method of claim 19, wherein the action of sending the timing-related information from a scanner to a resolver comprises the action of:
sending a time remaining indicator from the scanner to the resolver using a protocol.

21. The method of claim 19, wherein the action of sending the timing-related information from a scanner to a resolver comprises the action of:
sending a first line of the scan of the scanning target from the scanner to the resolver.

22. The method of claim 17, wherein the action of sending an instruction to a print engine responsive to the timing-related information and prior to completing the scan comprises the action of:
sending an initialize instruction to the print engine.

23. The method of claim 22, further comprising the action of:
warming up the print engine responsive to the initialize instruction.

24. The method of claim 17, wherein the action of sending an instruction to a print engine responsive to the timing-related information and prior to completing the scan comprises the action of:
sending a continue spinning instruction to the print engine.

25. The method of claim 24, further comprising the action of:
continuing to spin the print engine past a normal spin down threshold period responsive to the continue spinning instruction.

26. The method of claim 17, wherein the action of sending an instruction to a print engine responsive to the timing-related information and prior to completing the scan comprises the action of:
sending a spin down instruction to the print engine.

27. The method of claim 26, further comprising the action of:
canceling a ready state of the print engine responsive to the spin down instruction.

28. A multifunction device that is capable of accelerating the printing of a scanning target, the multifunction device comprising:
a scanning mechanism that is capable of scanning a scan target to produce an image of the scan target and that is capable of providing timing-related information for the scanning; and
a print engine that is capable of printing the image of the scan target as produced by the scanning mechanism;
wherein the multifunction device is adapted to manage a current state of the print engine responsive to a predicted time for completing the scanning as determinable from the timing-related information.

29. The multifunction device of claim 28, wherein the scanning mechanism and the print engine can, at least in part, jointly provide a copying function.

30. The multifunction device of claim 28, wherein the multifunction device manages the current state of the print engine responsive to the predicted time for completing the scanning so as to balance copying throughput against wear and tear of the print engine.

31. A method for accelerating printing, the method comprising actions of:
beginning a scan of a scanning target at a scanner;
sending a time remaining indicator from the scanner to a resolver;
analyzing, at the resolver, the time remaining indicator with respect to at least one characteristic that is associated with a print engine; and
sending an instruction from the resolver to the print engine responsive to the time remaining indicator and based on the analyzing.

32. The method of claim 31, further comprising the action of:
executing the instruction at the print engine.

33. The method of claim 31, further comprising the action of:
initializing the print engine responsive to the instruction.

34. The method of claim 31, further comprising the action of:
spinning down the print engine responsive to the instruction.

35. The method of claim 31, wherein the action of analyzing, at the resolver, the time remaining indicator with respect to at least one characteristic that is associated with a print engine comprises the action of analyzing the time remaining indicator with respect to at least one of an engine timing value of the print engine and a current engine state of the print engine.

36. The method of claim 31, further comprising the action of:
printing an image of the scanning target at the print engine.

37. The method of claim 36, wherein the actions of beginning a scan of a scanning target at a scanner and printing an image of the scanning target at the print engine comprise the action of copying the scanning target.

38. A multifunction device that is capable of accelerating the printing of a scanning target, the multifunction device configured to perform actions comprising:
scan and print one or more documents to thereby enable copying of the one or more documents;
predict a time to scanning completion for a scan of the one or more documents;
compare the time to scanning completion to a time period for readying a print engine; and
instruct the print engine to begin readying for printing when the time to scanning completion is or becomes less than or equal to the time period for readying the print engine.

39. An arrangement for accelerating the printing of a scanning target, the arrangement comprising:
means for scanning for scanning a scanning target and producing an electronic image thereof;
means for printing for printing the electronic image of the scanning target; and
means for resolving (i) for analyzing a time remaining to produce the electronic image of the scanning target in conjunction with at least one characteristic of the means for printing and (ii) for sending an instruction based on the analyzing to the means for printing.

40. The arrangement of claim 39, wherein the means for scanning sends the time remaining to produce the electronic image of the scanning target to the means for resolving.

41. The arrangement of claim 39, wherein the means for resolving derives the time remaining to produce the electronic image of the scanning target from receipt of a first scanning line of the electronic image of the scanning target.

42. A method for accelerating printing, the method comprising actions of:
beginning a scan of a subsequent scanning target of a copying batch at a scanner;
determining whether a time remaining for completion of the scan of the subsequent scanning target is less than or is equal to a threshold spinning time of a print engine; and
if so, transmitting a continue spinning instruction to the print engine.

43. The method of claim 42, further comprising the actions of:
receiving the continue spinning instruction at the print engine; and
continuing to spin the print engine past an autonomous spin down threshold period responsive to the receiving of the continue spinning instruction.

44. A method for print engine management, the method comprising actions of:
beginning a scan of a subsequent scanning target of a copying batch at a scanner;
determining whether a time remaining for completion of the scan of the subsequent scanning target is greater than a threshold spinning time of a print engine; and
if so, transmitting a cease spinning instruction to the print engine.

45. The method of claim 44, further comprising the actions of:
receiving the cease spinning instruction at the print engine; and
spinning down the print engine responsive to the receiving of the cease spinning instruction.
